(19) United States
(12) Patent Application Publication
(10) Pub. No.: US 2009/0102832 A1
(43) Pub. Date: Apr. 23, 2009

(54) SELECTIVE REFRESH OF COMPUTER-AIDED DESIGN DRAWINGS

(76) Inventors: Jay Behr, San Francisco, CA (US); Jian Zheng, Greenbrae, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/874,091

(22) Filed: Oct. 17, 2007

(51) Int. Cl. G06T 1/00

(52) U.S. Cl. 345/418

(57) ABSTRACT

Embodiments of the invention provide techniques for updating drawing elements of a first computer aided design (CAD) drawing to reflect changes to corresponding drawing elements in a second CAD drawing. A method for updating a CAD drawing may include receiving a selection of drawing elements from the second CAD drawing, where the first CAD drawing is derived, at least in part, from the drawing elements of the second CAD drawing. The method may also include identifying drawing elements of the first CAD drawing that correspond with the selected drawing elements of the second CAD drawing, updating a geometry of the identified drawing elements of the first CAD drawing to reflect a geometry of the corresponding drawing elements of the second CAD drawing, and preserving a visual appearance of drawing elements the first CAD drawing not updated.

### BACKGROUND OF THE INVENTION

1. Field of the Invention

The present invention generally relates to computer software. More specifically, the present invention relates to techniques for selectively refreshing a presentation drawing based on changes to a computer-aided design model.

2. Description of the Related Art

The term computer-aided design (CAD) generally refers to a broad variety of computer-based tools used by architects, engineers, and other construction and design professionals. CAD applications may be used to construct computer models representing virtually any real-world construct. For example, CAD applications may be used to compose computer models and drawings of an office building, an airplane, an electronic appliance, and the like. Once composed, these CAD models are often used to generate a variety of two-dimensional (2D) and 3D views such as plan, profile, section, and elevation views. Such views are often included in drawings used for designing and producing a given design, for example, architectural, construction, and engineering drawings. Additionally, CAD models may be used to generate drawings which are rendered in visually appealing styles. Such drawings (hereafter referred to as “presentation drawings”) may be used for purposes such as marketing, sales, architectural approvals, and the like.

In some cases, presentation drawings are initially created from CAD models by using rendering applications, for example the Impression® application program available from Autodesk, Inc. In such cases, the objects and lines that make up a CAD model are used to generate the basic geometry of a presentation drawing. Thereafter, the user of the rendering application will typically customize a presentation drawing by adding or modifying graphical elements, so as to achieve a particular visual style. One common customization is to apply a rendering style for the general look of the presentation drawing, for example a hand-drawn style, a pencil-drawn style, a watercolor style, and the like. Another type of customization is to add elements to the presentation drawing to make the drawing more presentable or to give the drawing a sense of scale. Some examples of such additions are landscape elements (e.g., trees, shrubs, grass, etc.), clouds, surface details and colors, and the like. Yet another type of customization is to modify graphical elements (i.e., to add, delete, or move elements) such that particular aspects of the design are emphasized (or de-emphasized). Yet another type of customization is to select specific layers of the presentation drawing to be displayed, and to order those layers. Yet another type of customization is to specify a point of view and a level of zoom for the presentation drawing.

In many cases, when a presentation drawing is initially rendered from a CAD model, the design process may not yet be complete. For example, architectural drawings frequently go through many revisions before being finalized. In such cases, if the CAD model is later changed, the presentation drawing may have to be rendered again so as to reflect the changed design. However, in conventional rendering applications, when a presentation drawing is rendered again, any customizations made in the original presentation drawing may be lost. That is, any manual work performed to customize the first presentation drawing may be overwritten by the new rendering and is, thus, wasted. Therefore, to complete the presentation drawing, the customizations have to be repeated. Further, if the CAD model is ever changed again, the customizations will have to be repeated yet again. Since such customizations are typically performed manually, the process of repeating the customizations is usually tedious and inefficient.

Accordingly, as the foregoing discussion demonstrates, there is a need in the art for an improved technique for generating presentation drawings when a related CAD model is modified.

### SUMMARY OF THE INVENTION

Embodiments of the invention provide techniques for selectively refreshing a presentation drawing to reflect changes to drawing elements in a source drawing.

A method for updating drawing elements of a first computer aided design (CAD) drawing to reflect changes to corresponding drawing elements in a second CAD drawing may include receiving a selection of drawing elements from the second CAD drawing, where the first CAD drawing is derived, at least in part, from the drawing elements of the second CAD drawing. The method may also include identifying drawing elements of the first CAD drawing that correspond with the selected drawing elements of the second CAD drawing, updating a geometry of the identified drawing elements of the first CAD drawing to reflect a geometry of the corresponding drawing elements of the second CAD drawing, and preserving a visual appearance of drawing elements the first CAD drawing not updated.

Advantageously, any customizations of the presentation drawing are preserved. For example, the first CAD drawing may provide a presentation view of the device, object or structure modeled by the second CAD drawing. The presentation view may include any number of stylistic enhancements to create a pleasing aesthetic appearance of for the device, object, or structure modeled by the second CAD drawing. As the underlying model may change, e.g., as part of the project design cycle, such changes may be imported into the presentation drawing, without disrupting the stylistic enhancements. Thus, users are not forced to repeatedly customize the presentation drawing as the underlying source drawing changes.

### BRIEF DESCRIPTION OF THE DRAWINGS

FIG. 1 is a block diagram illustrating a computer system configured to selectively refresh a presentation drawing, according to one embodiment of the invention.

FIG. 2A illustrates a screen display of a source drawing of a building design, according to one embodiment of the invention.

FIG. 2B illustrates a screen display of a presentation drawing of a building design, according to one embodiment of the invention.

FIGS. 3A-3B illustrate a screen display of a selective refresh tool, according to one embodiment of the invention.

FIG. 4A illustrates a screen display of a source drawing that has been modified by a user, according to one embodiment of the invention.

FIG. 4B illustrates a screen display after a presentation drawing has been selectively refreshed to capture changes made to the source drawing, according to one embodiment of the invention.

FIG. 5 illustrates a method for selectively refreshing a presentation drawing, according to one embodiment of the invention.

### DETAILED DESCRIPTION OF THE PREFERRED EMBODIMENTS

Embodiments of the invention allow a user to selectively refresh one or more portions of a presentation drawing, based on changes made to a source drawing. In one embodiment, a user may select elements of a source drawing to be used for refreshing corresponding elements of the presentation drawing. The presentation drawing may then be updated to reflect the most current state of the selected elements of the source drawing, without affecting other elements of the presentation drawing. As a result, the need to repeat previous user customizations of the presentation drawing may be reduced or eliminated.

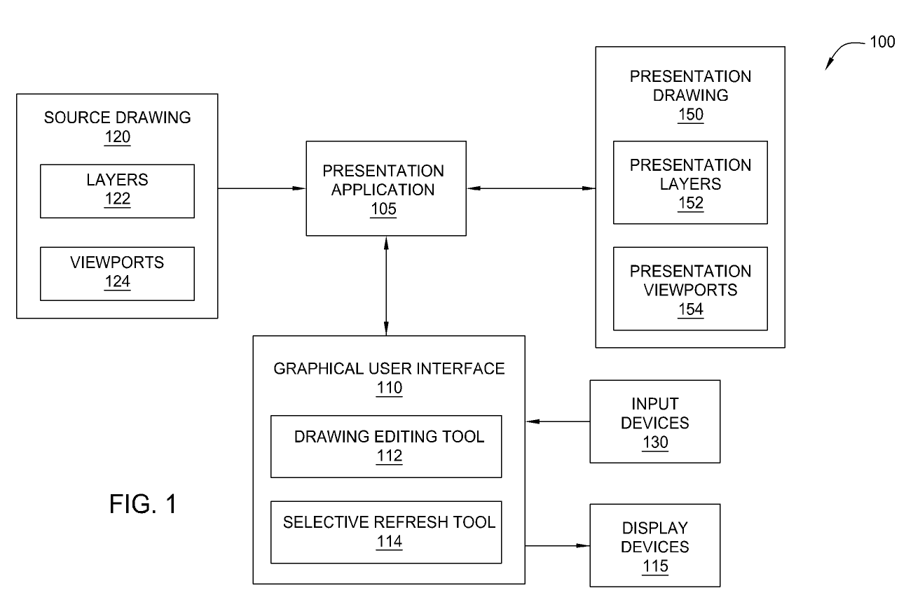

FIG. 1 is a block diagram illustrating a computer system 100 configured to selectively refresh a presentation drawing, according to one embodiment of the invention. The components illustrated in system 100 are included to be representative of computer software applications executing on existing computer systems, e.g., desktop computers, server computers, laptop computers, tablet computers, and the like. Of course, the software applications described herein are not limited to any particular computing system, and may be adapted to take advantage of new computing systems as they become available.

Additionally, the components illustrated in system 100 may be implemented as software applications that execute on a single computer system or on distributed systems communicating over computer networks such as local area networks or large, wide area networks, such as the Internet. For example, system 100 may include a graphical user interface (GUI) 110 executing on a client computer system at one physical location communicating with a presentation application 105 at another physical location. Of course presentation application 105 and GUI 110 may be integrated as a single software application. Also, presentation application 105 and GUI 110 may be provided as an application program (or programs) stored on computer readable media such as a CD-ROM, DVD-ROM, flash memory module, or other tangible storage media.

As shown, system 100 includes, without limitation, presentation application 105, GUI 110, a source drawing 120, a presentation drawing 150, display devices 115, and input devices 130. Presentation application 105 represents any software application used to compose presentation drawings 150. For example, presentation application 105 may be the Impression® application program (and associated utilities) available from Autodesk, Inc. Source drawing 120 represents any CAD files storing a CAD model, for example, AutoCAD® drawing files. Generally, CAD models are composed of elements (e.g., lines, squares, circles, etc.) which reflect the geometry of a given design. Such elements are hereafter referred to as “geometric elements.”

Source drawing 120 includes a set of layers 122 and a set of viewports 124. Generally, a layer is a transparent overlay on which users organize and group different kinds of geometric elements. Layers 122 are used to control the visibility of geometric elements as well as to assign properties to geometric elements. Viewports 124 are particular groupings of layers 122 which may be configured to present source drawing 120 from a particular point of view (e.g., plan view, elevation view, etc.) and for a particular scale (i.e., zoom.) Typically, a viewport is configured to present the point of view, scale, and layers of a drawing that are most relevant for a specific use.

In one embodiment, the presentation drawing 150 may be initially generated from source drawing 120. That is, the geometric elements included in source drawing 120 may be used to provide the underlying design of presentation drawing 150. Once generated, presentation drawing 150 may be customized by the user of presentation application 105 to achieve a visually appealing style. Typically, presentation drawings 150 may be used for purposes such as marketing, sales, architectural approvals, and the like. As shown, presentation drawing 150 includes a set of presentation layers 152 and a set of presentation viewports 154, which may be initially generated from layers 122 and viewports 124, respectively. Once generated, presentation layers 152 and presentation viewports 154 may be added to or modified by the user of presentation application 105. Additionally, presentation layers 152 and presentation viewports 154 may be selectively updated to include any changes made to layers 122 and viewports 124. Thus, substantial changes in geometry may be updated in presentation drawings without disrupting their customized appearance.

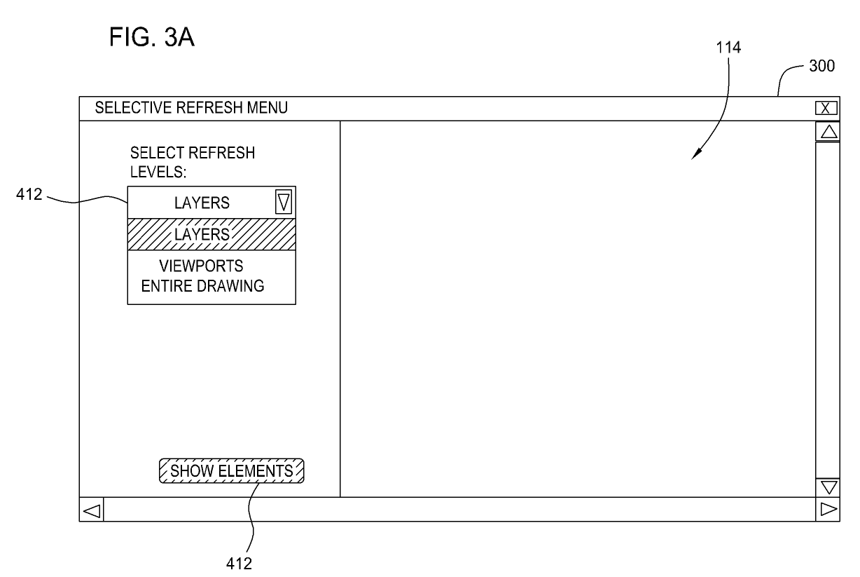

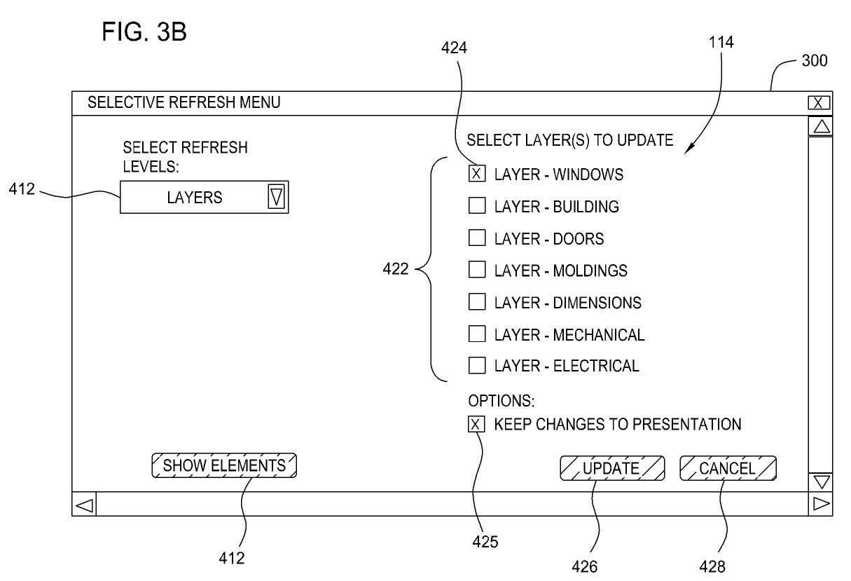

GUI 110 provides users with a graphical interface to the functions and features of presentation application 105. GUI 110 may include any combination of graphical elements such as windows, menus, buttons, ribbons, dialog boxes, etc. Illustratively, GUI 110 includes a set of drawing editing tools 112 and a selective refresh tool 114. Drawing editing tools 112 enable users to customize (i.e., to add and modify elements of) presentation drawing 150 to achieve a visually appealing style. Some examples of such user customizations may include adding a visual line style, adding decorative elements, removing superfluous elements, selecting layers to be displayed, ordering layers, and the like. Selective refresh tool 114 enables users to select specific layers 122 and/or viewports 124 of source drawing 120 to be used when updating corresponding presentation layers 152 and presentation viewports 154 in presentation drawing 150. Selective refresh tool 114 is described in more detail below with reference to FIGS. 3A-3B.

User input devices 130 typically include a mouse and a keyboard, and display devices 115 may include LCD or CRT displays. One of ordinary skill in the art will recognize, however, that the elements of system 100 shown in FIG. 1 have been simplified to highlight features of the present invention and that a typical system 100 may include a variety of additional elements and/or components.

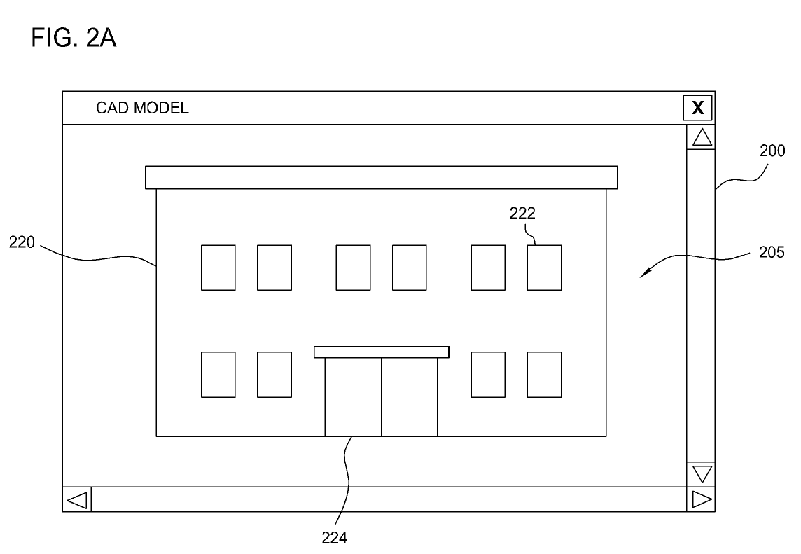

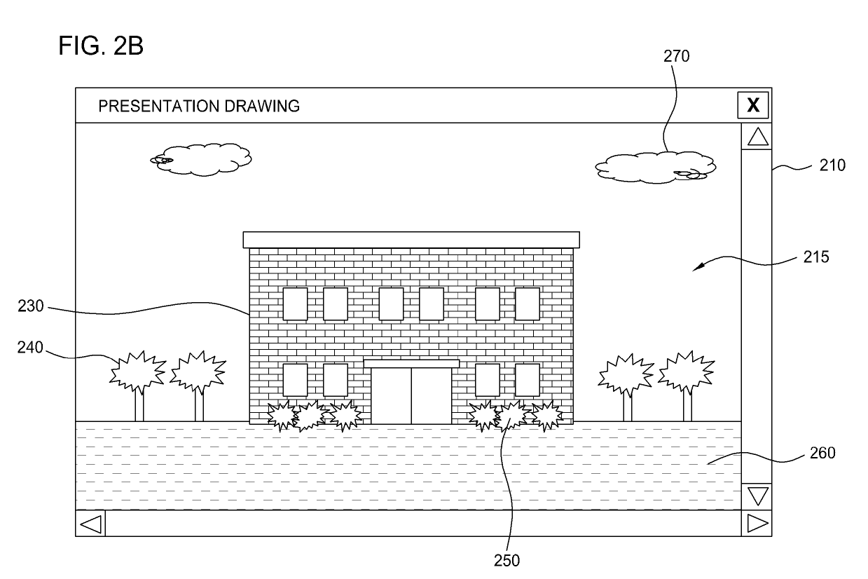

FIG. 2A illustrates a screen display 200 of a source drawing 205 of a building design, according to one embodiment of the invention. Screen display 200 represents a user interface to a CAD application, for example the Autocad® application program (and associated utilities) available from Autodesk, Inc. In this example, source drawing 205 is a CAD model of an architectural design, including a building 220, a set of doors 224, and a set of windows 222. Notably, source drawing 205 is composed from basic lines and shapes arranged in a particular geometry and does not include any decorative details or elements beyond the elements of the building itself. Typically, CAD models include geometric elements sufficient to enable the design and construction of a particular object and do not include decorative elements that are not part of the object.

FIG. 2B illustrates a screen display 210 of a presentation drawing 215 of a building design, according to one embodiment of the invention. In this example, presentation drawing 215 is based on source drawing 205. Specifically, presentation drawing 215 includes a rendered building 230, which is generated from the geometric elements of building 220 included in source drawing 205. Presentation drawing 215 has been customized by a user of a presentation application (e.g., presentation application 105) so as to achieve a desired aesthetic effect. Specifically, the user has added several decorative elements, namely a set of clouds 270, a grass lawn 260, a set of shrubs 250, and a set of trees 240. Additionally, the user has applied a brick texture to building 220.

FIGS. 3A-3B illustrate a screen display 300 of a selective refresh tool 114, according to one embodiment of the invention. As shown in FIG. 3A, selective refresh tool 114 includes a pull-down menu 412 and a “SHOW ELEMENTS” button 414. In one embodiment, a user of presentation application 105 may interact with pull-down menu 412 to specify how a presentation drawing should be updated based on changes to a source drawing. In this illustration, selective refresh tool 114 is configured to enable a selective refresh of presentation drawing 215 (shown in FIG. 2B) based on source drawing 205 (shown in FIG. 2A). In other words, changes to the geometry of building 220 in source drawing 205 (e.g., engineering or structural revisions) may be imported to presentation drawing 215.

As shown, pull-down menu 412 provides three levels of geometric elements available for the selective refresh. A first level is named “LAYERS,” meaning that the user may select individual layers of source drawing 205 for the selective refresh. A second layer is named “VIEWPORTS,” meaning that the user may select individual viewports of source drawing 205 for the selective refresh. A third level is named “ENTIRE DRAWING,” meaning that all geometric elements of source drawing 205 are included in the selective refresh. Of course, a person of skill in the art will recognize that other levels of geometric elements of a drawing may be used to perform a refresh. For example, a selective refresh may be performed at levels of elements that may include individual objects, blocks, etc. These and other permutations may be tailored to suit the needs of a particular case.

In the example shown in FIG. 3A, assume that the user selects the “INDIVIDUAL LAYERS” level and then selects the “SHOW ELEMENTS” button 414. This indicates that the user wishes to select individual layers of source drawing 205 to be used in refreshing presentation drawing 215. In response, as shown in FIG. 3B, selective refresh tool 114 is updated to present a set of checkboxes 422, an option checkbox 425, an “UPDATE” button 426, and a “CANCEL” button 428. Checkboxes 422 enable the user to select individual layers to be refreshed. In this example, the user has selected a “LAYER—WINDOWS” checkbox 424, indicating that a particular layer of source drawing 205, which includes all windows 222 of the building design included in FIG. 2A, is the only layer used to refresh presentation drawing 215. Additionally, the user has selected option checkbox 425, indicating that any existing changes which may have been made to presentation drawing 215 should be preserved while the selective refresh takes place. In one embodiment, the changes preserved by option checkbox 425 may be limited to user customizations of presentation drawing 215. Alternatively, the changes preserved by option checkbox 425 may include changes made to elements derived from the source drawing 205. That is, if the user has made any changes to rendered building 230 (e.g., adding a brick texture), those changes may be preserved during the selective refresh process. Once all selections of selective refresh tool 114 are completed, the user selects “UPDATE” button 426 to initiate the selective refresh. Of course, the example shown in FIGS. 3A-3B is for illustrative purposes only, and is not intended to limit the scope of the invention. It is contemplated that elements of a drawing may be selected by any suitable method.

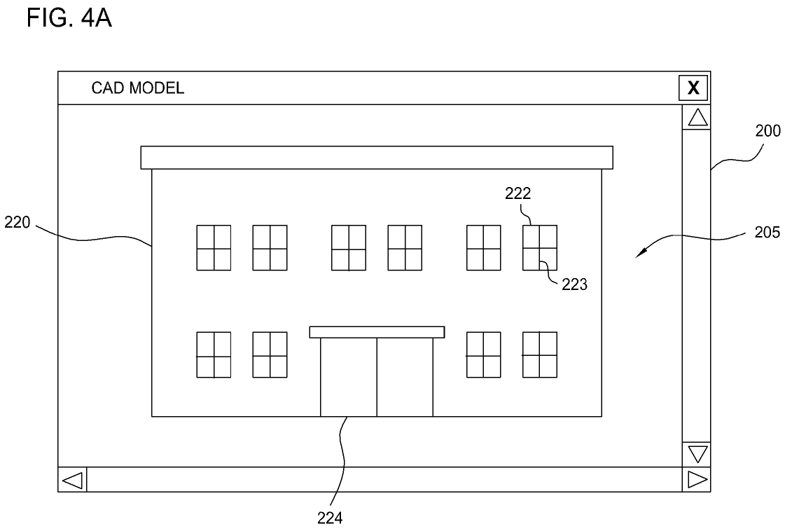

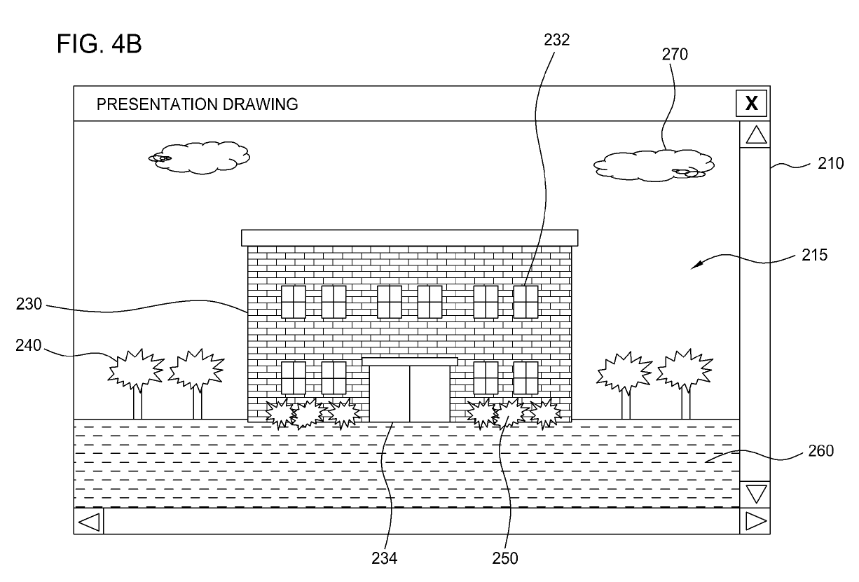

FIG. 4A illustrates a screen display 200 of a source drawing 205 that has been modified by a user, according to one embodiment of the invention. As shown, screen display 200 illustrates a modified version of source drawing 210 shown in FIG. 2A. Specifically, source drawing 205 has been modified by a user so that each window 222 has a grille 223, thus altering the geometry of windows 222.

FIG. 4B illustrates a screen display 210 after presentation drawing 215 has been selectively refreshed to capture changes made to the source drawing 205, according to one embodiment of the invention. The example shown in FIG. 4B reflects the situation that a user has performed the selective refresh illustrated in FIG. 3B. That is, the user of selective refresh tool 114 has selected the “LAYER—WINDOWS” checkbox 424 and the option checkbox 425, and the selective refresh has been completed. As shown in FIG. 4B, presentation drawing 215 has been updated to reflect the changes to the geometric elements of source drawing 205. Namely, windows 232 now include grilles, thus matching the addition of grilles 223 to windows 222 (as shown in FIG. 4A). Thus, the new geometry in the source drawing 205 has been incorporated into presentation drawing 215, while at the same time, other elements of presentation drawing 215, such as trees 240, shrubs 250, grass lawn 260, and clouds 270 remain unchanged. By maintaining the customized appearance of presentation drawing 215, while updating the underlying geometry, repeated work by the user is minimized.

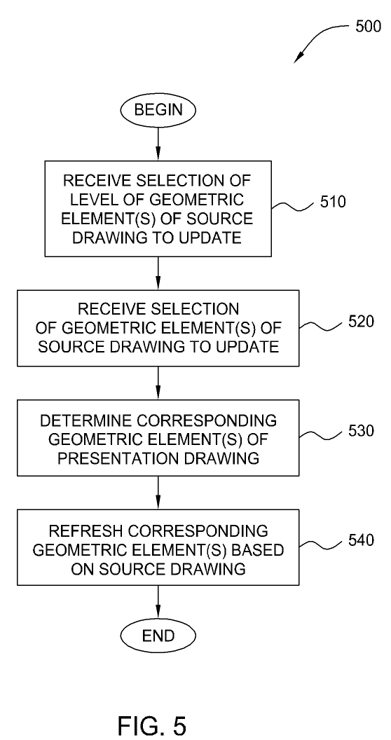

FIG. 5 illustrates a method 500 for selectively refreshing a presentation drawing, according to one embodiment of the invention. Persons skilled in the art will understand that, even though the method is described in conjunction with the systems of FIGS. 1-4B, any system configured to perform the steps of method 500, in any order, is within the scope of the present invention.

As shown, method 500 begins at step 510, where a user of a presentation application specifies a level at which the geometry of the source drawing should be used to update elements of the presentation drawing. This step may be performed by a user interacting with the selective refresh tool 114 illustrated in FIGS. 3A-3B. In one embodiment, the levels which may be selected include the layer, viewport, and global drawing levels. For example, the user may be presented with the drawing components present in the selected level (e.g., checkboxes 422 representing individual layers of source drawing 205). At step 520, the user selects one or more layers, viewports, etc., of the source drawing to use in updating corresponding drawings elements in the presentation drawings. For example, the “LAYER—WINDOWS” checkbox 424 of FIG. 3B may be selected to update the geometry of all of the drawing elements of the presentation drawing, based on the geometry of the corresponding windows in the source drawing present in the “WINDOWS” layer.

At step 530, geometric elements of a presentation drawing (e.g., presentation drawing 215) that correspond to the selected drawing elements of the source drawing (e.g., source drawing 120) are identified. In other words, the presentation application determines which drawing elements of the presentation drawing 215 to update as part of the selective refresh process. At step 540, the drawing elements of the presentation drawing identified by the presentation application in step 530 are refreshed, and thus reflect the current state of the corresponding drawing elements in the source drawing. After step 540, the method 500 ends.

Advantageously, embodiments of the invention may be used to selectively refresh a presentation drawing that is based on a source drawing, instead of having to manually recreate presentation drawings each time significant changes to the geometry of the source drawing occur. In one embodiment, a user may select geometric elements of a source drawing to be used for refreshing corresponding geometric elements of the presentation drawing. The presentation drawing may then be updated to reflect the most current state of a CAD model, without affecting other elements of the presentation drawing. As a result, previous customizations of the presentation may be preserved, thus reducing or eliminating repeated and wasted work by the user.

While the forgoing is directed to embodiments of the present invention, other and further embodiments of the invention may be devised without departing from the basic scope thereof, and the scope thereof is determined by the claims that follow.

What is claimed is:

1. A method for updating drawing elements of a first computer aided design (CAD) drawing to reflect changes to corresponding drawing elements in a second CAD drawing, comprising:
receiving a selection of drawing elements from the second CAD drawing, wherein the first CAD drawing is derived, at least in part, from the drawing elements of the second CAD drawing;
identifying drawing elements of the first CAD drawing that correspond with the selected drawing elements of the second CAD drawing;
updating a geometry of the identified drawing elements of the first CAD drawing to reflect a geometry of the corresponding drawing elements of the second CAD drawing; and
preserving a visual appearance of drawing elements the first CAD drawing that have not been updated.

2. The method of claim 1, further comprising receiving a selection of a level of the second CAD drawing, wherein the selection of drawing elements from the second CAD drawing is limited to drawing elements present in the selected level.

3. The method of claim 2, wherein the selection of the level of the second CAD drawing comprises at least one of a layer level, a viewport level, and a global level.

4. The method of claim 1, wherein the first CAD drawing includes one or more drawing elements not derived from the second CAD drawing.

5. The method of claim 4, wherein the one or more drawing elements not derived from the second CAD drawing include a layer having one or more drawing elements present in the first CAD drawing or a drawing style applied to one or more drawing elements present in the first CAD drawing.

6. The method of claim 4, wherein the one or more drawing elements not derived from the second CAD drawing remain in the first CAD drawing after the geometry of the identified drawing elements of the first CAD drawing have been updated to reflect the geometry of the corresponding drawing elements of the second CAD drawing.

7. The method of claim 1, wherein the geometry of the drawing elements of the second CAD drawing represent a model of the geometry of a real-world object, device, or structure.

8. A computer-readable storage medium storing instructions that when executed by a processor cause the processor to update drawing elements of a first computer aided design (CAD) drawing to reflect changes to corresponding drawing elements in a second CAD drawing, by performing the steps of:
receiving a selection of drawing elements from the second CAD drawing, wherein the first CAD drawing is derived, at least in part, from the drawing elements of the second CAD drawing;
identifying drawing elements of the first CAD drawing that correspond with the selected drawing elements of the second CAD drawing;
updating a geometry of the identified drawing elements of the first CAD drawing to reflect a geometry of the corresponding drawing elements of the second CAD drawing; and
preserving a visual appearance of drawing elements the first CAD drawing that have not been updated.

9. The computer-readable storage medium of claim 8, wherein the steps further comprise, receiving a selection of a level of the second CAD drawing, wherein the selection of drawing elements from the second CAD drawing is limited to drawing elements present in the selected level.

10. The computer-readable storage medium of claim 9, wherein the selected level of the second CAD drawing includes at least one of one or more drawing layers, one or more drawing viewports, and a global level.

11. The computer-readable storage medium of claim 8, wherein the first CAD drawing includes one or more drawing elements not derived from the second CAD drawing.

12. The computer-readable storage medium of claim 11, wherein the one or more drawing elements not derived from the second CAD drawing include a layer having one or more drawing elements present in the first CAD drawing or a drawing style applied to one or more drawing elements present in the first CAD drawing.

13. The computer-readable storage medium of claim 11, wherein the one or more drawing elements not derived from the second CAD drawing remain in the first CAD drawing after the geometry of the identified drawing elements of the first CAD drawing have been updated to reflect the geometry of the corresponding drawing elements of the second CAD drawing.

14. The computer-readable storage medium of claim 8, wherein the geometry of the drawing elements of the second CAD drawing represent a model of the geometry of a real-world object, device, or structure.

15. A method for updating drawing elements of a first computer aided design (CAD) drawing to reflect changes to corresponding drawing elements in a second CAD drawing, comprising:
selecting the first CAD drawing and the second CAD drawing; and
invoking a selective refresh tool provided by a CAD application, wherein the selective refresh tool is configured to:
receive a selection of drawing elements from the second CAD drawing, wherein the first CAD drawing is derived, at least in part, from the drawing elements of the second CAD drawing,
identify drawing elements of the first CAD drawing that correspond with the selected drawing elements of the second CAD drawing,
update a geometry of the identified drawing elements of the first CAD drawing to reflect a geometry of the corresponding drawing elements of the second CAD drawing; and
preserve a visual appearance of drawing elements the first CAD drawing that have not been updated.

16. The method of claim 15, wherein the selective refresh tool is further configured to receive a selection of a level of the second CAD drawing, wherein the selection of drawing elements from the second CAD drawing is limited to drawing elements present in the selected level.

17. The method of claim 16, wherein the selection of the level of the second CAD drawing comprises at least one of a layer level, a viewport level, and a global level.

18. The method of claim 15, wherein the first CAD drawing includes one or more drawing elements not derived from the second CAD drawing.

19. The method of claim 18, wherein the one or more drawing elements not derived from the second CAD drawing include a layer having one or more drawing elements present in the first CAD drawing or a drawing style applied to one or more drawing elements present in the first CAD drawing.

20. The method of claim 18, wherein the one or more drawing elements not derived from the second CAD drawing remain in the first CAD drawing after the geometry of the identified drawing elements of the first CAD drawing have been updated to reflect the geometry of the corresponding drawing elements of the second CAD drawing.

21. The method of claim 15, wherein the geometry of the drawing elements of the second CAD drawing represent a model of the geometry of a real-world object, device, or structure.
